(19) United States
(12) Patent Application Publication
(10) Pub. No.: US 2015/0275067 A1
(43) Pub. Date: Oct. 1, 2015

(54) CARBON PARTICLES AND THEIR USE IN THE CHEMICAL TREATMENT OF RESERVOIRS

(71) Applicant: William Marsh Rice University

(72) Inventors: Mohammad A. Kabbani, Houston, TX (US); Ahmad Toufic Kabbani, Houston, TX (US); Pulickel M. Ajayan, Houston, TX (US)

(73) Assignee: William Marsh Rice University

(21) Appl. No.: 14/672,450

(22) Filed: Mar. 30, 2015

Related U.S. Application Data
(60) Provisional application No. 61/971,639, filed on Mar. 28, 2014.

(51) Int. Cl. C09K 8/528; E21B 37/06; E21B 43/16; E21B 41/02; C09K 8/536; C09K 8/58

(52) U.S. Cl. CPC C09K 8/528; C09K 8/536; C09K 8/58; E21B 43/16; E21B 41/02; E21B 37/06; C09K 2208/04

(57) ABSTRACT

In some embodiments, the present disclosure pertains to methods of making carbon particles by mixing a carbon source (e.g., a carbohydrate) with a dehydrating agent (e.g., concentrated sulfuric acid) to result in the assembly of the carbon particles from the carbon source. In some embodiments, the methods of the present disclosure also include a step of associating the carbon particles with a filler, such as a scale inhibitor. Additional embodiments of the present disclosure pertain to carbon particles that are assembled by the methods of the present disclosure. Further embodiments of the present disclosure pertain to methods of chemically treating a reservoir by introducing the carbon particles of the present disclosure into the reservoir, where at least one component of the filler is released into the reservoir from the carbon particles to chemically treat the reservoir in various manners (e.g., scale inhibition, corrosion inhibition, and/or shale inhibition).

### CROSS-REFERENCE TO RELATED APPLICATIONS

This application claims priority to U.S. Provisional Patent Application No. 61/971,639, filed on Mar. 28, 2014. The entirety of the aforementioned application is incorporated herein by reference.

### STATEMENT REGARDING FEDERALLY SPONSORED RESEARCH

This invention was made with government support under Grant No. FA9550-12-1-0035, awarded by the U.S. Department of Defense. The government has certain rights in the invention.

### BACKGROUND

Current materials and methods for enhancing oil recovery from various reservoirs have numerous limitations, including efficiency, costs, and prolonged use. Therefore, new materials and methods are needed for enhancing oil recovery from various reservoirs.

### SUMMARY

In some embodiments, the present disclosure pertains to methods of making carbon particles. In some embodiments, such methods include mixing a carbon source (e.g., a carbohydrate) with a dehydrating agent (e.g., concentrated sulfuric acid) to form a reaction mixture, where the mixing results in the assembly of the carbon particles from the carbon source. In some embodiments the assembly occurs through the dehydration of the carbon source by the dehydrating agent. In some embodiments, the assembly occurs through the polymerization of the carbon source.

In some embodiments, the methods of the present disclosure also include a step of associating the carbon particles with a filler. In some embodiments, the associating occurs in situ during the mixing step. In some embodiments, the associating occurs after the formation of the carbon particles.

In some embodiments, the filler includes, without limitation, acids, scale inhibitors, corrosion inhibitors, shale inhibitors, and combinations thereof. In some embodiments, the filler becomes encapsulated within the carbon particles.

Additional embodiments of the present disclosure pertain to carbon particles that are formed by the methods of the present disclosure. In some embodiments, the carbon particles include a carbon source and a filler associated with the carbon particle. In some embodiments, the carbon particles are in the shape of at least one of shells, discs, spheres, tubes, encapsulated structures, and combinations thereof. In some embodiments, the carbon particles are in the shape of shells. In some embodiments, the carbon particles include a hydrophobic surface and a hydrophilic core.

Further embodiments of the present disclosure pertain to methods of chemically treating a reservoir by utilizing the carbon particles of the present disclosure. In some embodiments, the method includes a step of introducing carbon particles into the reservoir, where the carbon particles are associated with a filler, and where at least one component of the filler is released into the reservoir from the carbon particles. Thereafter, the at least one component of the filler chemically treats the reservoir in various manners.

In some embodiments, the at least one component of the filler is an atom, a functional group, or a moiety associated with the filler (e.g., a proton group associated with the filler). In some embodiments, the at least one component of the filler includes an entire filler molecule.

In some embodiments, the at least one component of the filler chemically treats the reservoir through at least one of scale inhibition, corrosion inhibition, shale inhibition, and combinations thereof. In some embodiments, the chemical treatment results in enhancement of oil and gas recovery from the reservoir.

In some embodiments, the reservoir that is chemically treated includes, without limitation, carbonate reservoirs, limestone reservoirs, carbonate petroleum reservoirs, sandstone reservoirs, oil and gas reservoirs, and combinations thereof. In some embodiments, the reservoir is an oil and gas carbonate reservoir. In some embodiments, the chemical treatment results in enhancement of oil and gas recovery from the reservoir. In some embodiments, the methods of the present disclosure also include a step of recovering the carbon particles from the reservoir and reusing the recovered carbon particles.

### DESCRIPTION OF THE FIGURES

FIGS. 1A and 1B provide schemes of a method of making carbon particles (FIG. 1A) and utilizing the carbon particles to chemically treat reservoirs (FIG. 1B).

FIG. 2 provides an illustration of a protocol for the synthesis of carbon particles (i.e., carbon shells).

FIGS. 3A-3C provide scanning electron microscopy (SEM) images of carbon shells.

FIGS. 4A and 4B show Raman spectra that were used to identify the structure of carbon shells. FIG. 4A is a Raman spectrum of a carbon shell described in Example 1.1. FIG. 4B is a Raman spectrum of various carbon shell precursors.

FIGS. 5A and 5B show results relating to the dynamic mechanical analysis (DMA) of hard and soft carbon shells, including stiffness (FIG. 5A) and strain (FIG. 5B) experiments.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

In recent years, the demand for energy has increased rapidly. For instance, it has been reported that more than 85% of the world's energy consumption comes from fossil fuels. Furthermore, the energy demand could rise by 53% between now and 2030. Accordingly, more oil and natural gas reserves are needed.

Recent analysis indicates that more than 60% of the world's oil and 40% of the world's gas reserves are held in carbonate reservoirs. In addition, the Middle East has 62% of the world's conventional oil reserves. Moreover, 70% of these reserves are in carbonate reservoirs. Likewise, the Middle East has approximately 40% of the world's gas reserves. 90% of these gas reserves are in carbonate reservoirs.

The aforementioned statistics indicate the importance of carbonate reservoirs. However, there are significant challenges in terms of oil and gas recovery due to the highly complex internal structure and specificity of carbonate reservoirs.

For instance, the average recovery factor—the ratio of recoverable oil to the volume of oil originally in place—for all reservoirs is about 35%. However, it is recognized that recovery factors are higher for sandstone reservoirs than for carbonate reservoirs.

Furthermore, carbonate reservoirs present a number of specific characteristics posing complex challenges in reservoir characterization, production, and management. Among the geological problems encountered in oil reservoirs are vugular porosity and saltwater content in the rock. The former occurs in limestone reservoirs. Acidic ground water percolates down through the limestone, dissolving networks of tiny, interconnected channels or vugs. Thus, vugular porosity is typically narrow and will lead to a reduction in the reservoir oil efficiency.

When migrating into a reservoir rock, oil and gas do not clean all the saltwater from the rock's pores. The slow saltwater displacement mechanisms and their effectiveness are of great interest in deciding profitability of the reservoir. Such water occupies some of the porosity, reducing the volume available for oil or gas.

Water-based drilling fluids have been used to recover oil. However, water-based drilling fluids may cause swelling of the clay minerals in shale formations, which will lead to major problems for the drilling operations.

According to statistics, shales constitute about 75% of the drilled sections in oil and gas wells and relate to about 90% of the wellbore instability problems. Examples of such problems involve hole collapse, tight hole, stuck pipe, poor hole cleaning, hole enlargement, plastic flow, fracturing, lost circulation, and well control. Furthermore, the dispersed clay might aggregate on the surface of bit or drilling tools, leading to bit balling and reduction in penetrating rate.

Extensive research has been carried out towards controlling scale formation from brines often associated with geopressured energy production, coproduction wells, and oil wells that produce large amounts of water. As brine flows out of the formation and up the well, the pressure drops. According to Henry's law, this drop in pressure will lead to a decrease in the dissolved carbon dioxide and consequently to a rise in pH. This rise in pH causes the aqueous bicarbonate to react with OH⁻ to precipitate CaCO₃ in the formation pore near the wellbore, on the production tubing walls, or in surrounding equipment.

Thus, mineral scale decreases the permeability of the formation, reduces well productivity, and shortens the lifetime of production equipment. As such, chemical scale inhibitors have been used in production wells to prevent scaling in the formation, in the production lines down hole, and at the surface.

Traditionally, liquid chemical inhibitors were used to control the formation of scale in oil and gas production. Scale inhibitors are generally evaluated in terms of their duration action, their minimal interruption of production for treatment, and their cost.

Liquid chemical scale inhibitors are administered through batch, continuous or squeezed applications. In the scale inhibitor squeeze (SIS), the scale inhibitor is squeezed or injected near the wellbore region where the chemical reacts with formation rock and is retained through adsorption or/and precipitation. This method is well established for scale control in both onshore and offshore oil and gas production systems. SIS treatments are designed to ensure that the chemical remains in the system continually with desorption or dissolution of the chemical from the matrix, ensuring that the chemical remains in the brine continuously.

However, pre-squeeze treatments, fluids, and rock compatibility evaluation are indispensable before applications in the field. Moreover, the success of SIS treatment depends on the scale inhibitor return profile, which is dependent on the place where the chemicals are applied. Injecting large volumes of chemical fluids into the formation rarely results in high water-cuts and productivity losses, due to premature precipitation near wellbore area, after the SIS treatments. In addition, well livening poses a major problem after the SIS treatment with significant quantities of water-based fluids.

Encapsulated treatments have the advantage over the SIS treatments in minimizing such injectivity adverse effects. In addition, low MIC requirements for CaCO₃ scaling wells provides an opportunity for cost-effective encapsulated alternative treatments to SIS for the wells, which have sufficient ratholes.

In the encapsulated scale inhibitor treatment, the main advantage is placement of the chemical fluid into the rathole rather than squeezing into the formation. The scale inhibitor is released into the brine in the rathole by diffusion through a semipermeable polymer membrane.

A major problem in the use of conventional squeeze formation in a carbonate formation is that most of the acidic phosphonate inhibitor is quickly precipitated as calcium phosphonate near the formation face, which will offer limited reservoir protection distance near the wellbore. The treatment of this problem is complex and will require: a containment basin, a chemical tank, a pump, a power supply system, and tubing to feed the chemical from the pump to the well.

Therefore, a need exists for exploring new chemical formulations and chemical treatment strategies to ensure more efficient recovery of oil and gas from various reservoirs. Various embodiments of the present disclosure address this need.

In some embodiments, the present disclosure pertains to methods of making carbon particles that can be used to chemically treat various reservoirs. In some embodiments, the present disclosure pertains to the produced carbon particles. In some embodiments, the present disclosure pertains to methods of chemically treating reservoirs by introducing the particles of the present disclosure into the reservoirs.

As set forth in more detail herein, various methods may be utilized to make various types of carbon particles. Moreover, various methods may be utilized to chemically treat various types of reservoirs by the carbon particles of the present disclosure.

Methods of Making Carbon Particles

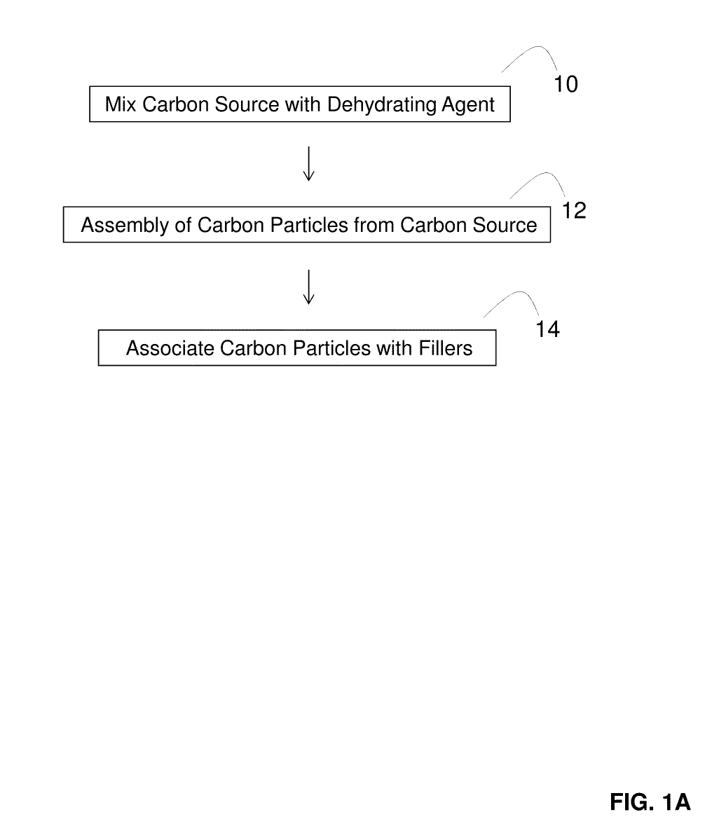

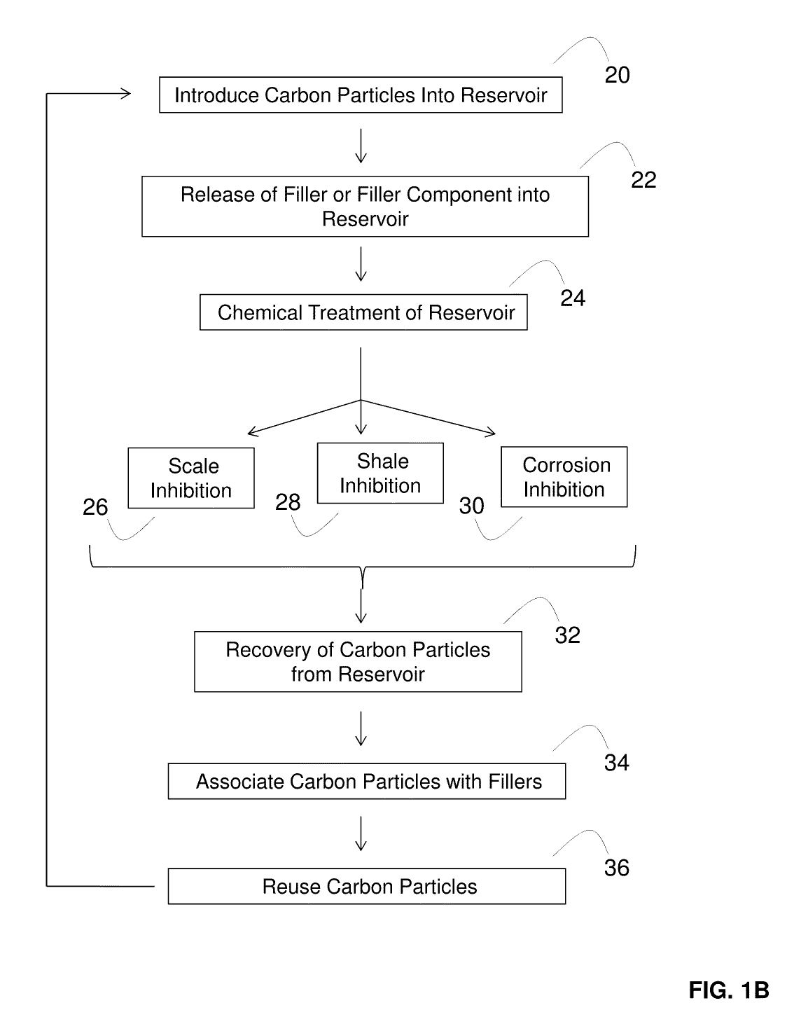

Various methods may be utilized to make carbon particles. In some embodiments that are illustrated in FIG. 1A, the methods include mixing a carbon source with a dehydrating agent to form a reaction mixture (step 10), where the mixing results in assembly of the carbon particles from the carbon source (step 12). In some embodiments, the methods of the present disclosure also include a step of associating the carbon particles with a filler (step 14). As set forth in more detail herein, various methods may be utilized to mix various types of carbon sources with various types of dehydrating agents. Moreover, various methods may be utilized to associate the carbon particles with various types of fillers.

Carbon Sources

The methods of the present disclosure can utilize various types of carbon sources to make carbon particles. In some embodiments, suitable carbon sources include any carbon-containing compound that has one or more hydrating groups (e.g., hydrogen groups, oxygen groups, H₂O groups, and the like). In some embodiments, the carbon source includes, without limitation, carbohydrates, polymers, biopolymers, carbon nanotubes, graphenes, graphene oxides, graphites, precursors thereof, derivatives thereof, and combinations thereof.

In some embodiments, the carbon sources of the present disclosure include carbohydrates. In some embodiments, the carbohydrates include, without limitation, sugars, monosaccharides, disaccharides, polysaccharides, glucose, sucrose, fructose, maltose, galactose, ribose, starch, cellulose, amylose, pyranose, and combinations thereof. Additional carbon sources can also be envisioned. For instance, in some embodiments, the carbon sources of the present disclosure may be derived from natural products, such as fruits (e.g., coconuts).

Dehydrating Agents

The methods of the present disclosure can also utilize various types of dehydrating agents. In some embodiments, suitable dehydrating agents include any compound that has dehydrating activity (e.g., compounds that remove water from a carbon source). In some embodiments, dehydrating agents include, without limitation, desiccants, acids, bases, salts, and combinations thereof.

In some embodiments, suitable dehydrating agents include, without limitation, sulfuric acid, sodium hydroxide, potassium hydroxide, phosphorus pentoxide, copper sulfate, calcium chloride, zinc chloride, barium perchlorate, calcium perchlorate, magnesium perchlorate, calcium sulfate, calcium oxide, and combinations thereof. Additional dehydrating agents can also be envisioned.

Mixing of Carbon Sources with Dehydrating Agents

Various methods may be utilized to mix carbon sources with dehydrating agents. For instance, in some embodiments, the mixing occurs by stirring the reaction mixture. In some embodiments, the mixing occurs by at least one of sonication, agitation, centrifugation, heating, and combinations thereof. Additional methods of mixing can also be envisioned.

The mixing of carbon sources with dehydrating agents can occur in various media. For instance, in some embodiments, the mixing occurs in an organic solvent. In some embodiments, the organic solvent includes, without limitation, acetic acid, acetone, acetonitrile, benzene, butanol, chloroform, cyclohexane, ethanol, methanol, propanol, pyridine, tetrahydrofuran (THF), toluene, xylene, and combinations thereof. Additional media can also be envisioned.

Assembly of Carbon Particles

The mixing of carbon sources with dehydrating agents can result in the assembly of carbon particles from the carbon source. Without being bound by theory, it is envisioned that the assembly of carbon particles can occur in various manners. For instance, in some embodiments, the assembly of carbon particles includes dehydration of the carbon source by the dehydrating agent. In some embodiments, the assembly of carbon particles includes polymerization of the carbon source. In some embodiments, the polymerization of the carbon source occurs as a result of the dehydration of the carbon source.

Additional methods by which carbon particles assemble can also be envisioned. For instance, in some embodiments, carbon particle assembly may involve a heating of the reaction mixture. In some embodiments, the heating step includes microwave heating. In some embodiments, the heating step can result in the carbonization of the formed carbon particle. In some embodiments, the heating step can occur in the presence of a base, such as potassium hydroxide (KOH). In some embodiments, the heating step involves the microwave heating of the reaction mixture in the presence of KOH (e.g., embodiments where a natural product such as coconut is utilized as a carbon source for the carbon particle).

Association of Carbon Particles with Fillers

In some embodiments, the methods of the present disclosure can also include a step of associating carbon particles with a filler. In some embodiments, the association occurs in situ during the mixing step. For instance, in some embodiments, the association occurs by adding a filler to the reaction mixture during the mixing of a carbon source with a dehydrating agent. In some embodiments, the association occurs after the formation of the carbon particles. For instance, in some embodiments, the association occurs by mixing formed carbon particles with a filler.

In some embodiments, the association of fillers with carbon particles involves a heating step. For instance, in some embodiments, a reaction mixture containing a filler and a carbon source may be heated in order to associate the carbon particles with the fillers. In some embodiments, the heating involves microwave heating. Additional methods of associating carbon particles with a filler can also be envisioned.

The carbon particles of the present disclosure can become associated with various types of fillers. In some embodiments, the filler includes, without limitation, acids, scale inhibitors, corrosion inhibitors, shale inhibitors, and combinations thereof. In some embodiments, the filler includes, without limitation, carbonates, polycarboxylic acids, polycarboxylates, polyaspartates, polysuccinates, phosphonates, polyprotic organic acids, polyaspartic acid, polymaleic acid, composite acids, and combinations thereof. In some embodiments, the filler includes a single molecule. In some embodiments, the filler includes multiple molecules.

In some embodiments, the filler associated with carbon particles includes one or more acids. In some embodiments, the acid includes, without limitation, sulfuric acid, polycarboxylic acids, dicarboxylic acids, oxalic acid, malonic acid, succinic acid, adipic acid, polyaspartic acid, polyprotic organic acids, polymaleic acid, composite acids, and combinations thereof. In some embodiments, the filler associated with carbon particles includes at least two different acids.

In some embodiments, the filler associated with carbon particles includes one or more scale inhibitors. Scale inhibitors generally refer to compounds that prevent or interfere with scale formation. In some embodiments, the scale inhibitor includes, without limitation, nitrilotriacetates, phosphonates, polyphosphonates, acrylic acids, polyacrylic acids, phosphinopolyacrylates, maleic acids, polymaleic acid, phosphonic acids, sulfonic acids, polyaspartate, carboxy methyl inulin, polycarboxylic acid, and combinations thereof.

In some embodiments, the filler associated with carbon particles includes one or more corrosion inhibitors. Corrosion inhibitors generally refer to compounds that prevent or interfere with scale formation. In some embodiments, the corrosion inhibitor includes, without limitation, benzotriazole, zinc phosphates, zinc dithiophosphates, benzalkonium chloride, and combinations thereof.

In some embodiments, the filler associated with carbon particles includes one or more shale inhibitors. Shale inhibitors generally refer to compounds that prevent or interfere with shale formation. In some embodiments, the shale inhibitor includes, without limitation, hexanediamines, phosphonic acids, glycols, polyacrylamides, and combinations thereof.

The fillers of the present disclosure may be derived from various sources. For instance, in some embodiments, the filler may be derived from the dehydrating agent (e.g., sulfuric acid). In some embodiments, the filler may be a component of the dehydrating agent (e.g., filler as the proton group of sulfuric acid). In some embodiments, the filler may be added from an exogenous source to the reaction mixture.

The fillers of the present disclosure may be in various forms. For instance, in some embodiments, the fillers may be in solid form, liquid form, gaseous form, and combinations of such forms. In some embodiments, the fillers of the present disclosure may be in solid form. In some embodiments, the fillers of the present disclosure may include solid scale inhibitors. In some embodiments, the fillers of the present disclosure may be in liquid form.

The fillers of the present disclosure can become associated with carbon particles in various manners. For instance, in some embodiments, the fillers of the present disclosure can become associated with carbon particles through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof. In some embodiments, the fillers of the present disclosure become encapsulated within carbon particles. In some embodiments, the fillers of the present disclosure become infused with the carbon particles. Additional modes of association of fillers with carbon particles can also be envisioned.

Additional Steps

The methods of the present disclosure may include additional steps. For instance, in some embodiments, the methods of the present disclosure also include a step of removing dehydrating agents from the assembled carbon particles. In some embodiments, the removal occurs by adding water to the reaction mixture and separating the assembled carbon particles from the reaction mixture.

In some embodiments, the methods of the present disclosure can include a step of drying the assembled carbon particles. In some embodiments, the drying occurs by exposing the carbon particles to organic solvents. In some embodiments, the drying occurs by incubating the carbon particles in an oven.

In some embodiments, the methods of the present disclosure can include a step of coating the assembled carbon particles with one or more coating agents. In some embodiments, the coating agents can include, without limitation, lubricating agents, surfactants, friction reducing materials, and combinations thereof.

Carbon Particles

The methods of the present disclosure can be utilized to form various types of carbon particles. Additional embodiments of the present disclosure pertain to carbon particles that can be used to chemically treat a reservoir.

In some embodiments, the carbon particles of the present disclosure include a carbon source and a filler associated with the carbon particles. The carbon particles of the present disclosure can contain various types of carbon sources. Suitable carbon sources were described previously.

The carbon particles of the present disclosure can also be associated with various types of fillers in various manners. Suitable fillers and their association with carbon particles were also described previously.

The carbon particles of the present disclosure can have various shapes. For instance, in some embodiments, the carbon particles of the present disclosure are in the shapes of at least one of shells, discs, spheres, tubes, encapsulated structures, and combinations thereof. In some embodiments, the carbon particles of the present disclosure are in the shape of shells.

In some embodiments, the carbon particles of the present disclosure include a hydrophobic surface and a hydrophilic core. In some embodiments, the fillers in the carbon particles of the present disclosure are associated with the hydrophilic core.

The carbon particles of the present disclosure can have various surface areas. For instance, in some embodiments, the carbon particles of the present disclosure have surface areas that range from about 500 m²/g to about 2,500 m²/g. In some embodiments, the carbon particles of the present disclosure have surface areas that range from about 1,000 m²/g to about 2,000 m²/g. In some embodiments, the carbon particles of the present disclosure have surface areas that range from about 1,200 m²/g to about 1,750 m²/g.

The carbon particles of the present disclosure can also have various diameters. For instance, in some embodiments, the carbon particles of the present disclosure include diameters that range from about 5 μm to about 500 μm. In some embodiments, the carbon particles of the present disclosure include diameters of about 20 μm.

The carbon particles of the present disclosure can also have various densities. For instance, in some embodiments, the carbon particles of the present disclosure include densities that range from about 250 mg/cm³ to about 1,000 mg/cm³. In some embodiments, the carbon particles of the present disclosure include densities that range from about 500 mg/cm³ to about 750 mg/cm³. In some embodiments, the carbon particles of the present disclosure include densities that range from about 430 mg/cm³ to about 650 mg/cm³.

The carbon particles of the present disclosure can also have various acid capacities. For instance, in some embodiments, the carbon particles of the present disclosure have acid capacities ranging from about 0.5 moles of H⁺/mg to about 10 moles of H⁺/mg. In some embodiments, the carbon particles of the present disclosure have an acid capacity of about 1 mole of H⁺/mg.

Methods of Chemically Treating Reservoirs

In additional embodiments, the present disclosure pertains to methods of chemically treating a reservoir by utilizing the carbon particles of the present disclosure. In some embodiments illustrated in FIG. 1B, the methods of the present disclosure include a step of introducing carbon particles that are associated with a filler into a reservoir (step 20). Thereafter, at least one component of the filler is released into the reservoir from the carbon particles (step 22). Next, the at least one component of the filler chemically treats the reservoir by various manners (step 24), such as scale inhibition (step 26), shale inhibition (step 28), corrosion inhibition (step 30), and combinations of such treatments. In some embodiments, the methods of the present disclosure can also include one or more additional steps of recovering the carbon particles from the reservoir (step 32), associating the recovered carbon particles with additional fillers (step 34), and reusing the carbon particles (step 36).

The methods of the present disclosure can utilize various types of carbon particles that are associated with various types of fillers. Suitable carbon particles and fillers were described previously. As set forth in more detail herein, various methods may be utilized to introduce carbon particles into various types of reservoirs. Moreover, the release of at least one component of a filler into a reservoir from the carbon particles can occur in various manners. Furthermore, the at least one component of the filler can chemically treat reservoirs in various ways. Moreover, various methods may be utilized to recover carbon particles from a reservoir and associate the recovered carbon particles with additional fillers for reuse.

Introduction of Carbon Particles into Reservoirs

Various methods may be utilized to introduce carbon particles into a reservoir. For instance, in some embodiments, the carbon particles are introduced into a reservoir by injection. In some embodiments, the injection can occur by pumping the carbon particles of the present disclosure into the reservoir. In some embodiments, the pumping occurs by the utilization of a pump. In some embodiments, the injection can occur by physically pouring the carbon particles of the present disclosure into a reservoir.

In some embodiments, the carbon particles of the present disclosure are added to a reservoir by themselves followed by gas. In some embodiments, the carbon particles of the present disclosure are added simultaneously to a reservoir with gas by co-injection. In some embodiments, the carbon particles of the present disclosure are added to a reservoir without any gases.

Reservoirs

The methods of the present disclosure may be applied to various types of reservoirs. For instance, in some embodiments, the reservoir may be part of a geological structure. In some embodiments, the geological structure may include a downhole environment, such as an oil well or a subterranean formation. In some embodiments, the geological structure may be associated with various types of rocks, such as carbonates, sandstone, dolomite, calcite, neutral formations, cationic formations, anionic formations, clays, shale, and combinations thereof.

In some embodiments, the reservoir may be a sub-surface formation, such as a well. In some embodiments, the reservoir may be penetrated by at least one vertical well. In some embodiments, the reservoir may be penetrated by at least one horizontal well. In some embodiments, the reservoir may include, without limitation, carbonate reservoirs, limestone reservoirs, carbonate petroleum reservoirs, sandstone reservoirs, oil and gas reservoirs, and combinations thereof.

In some embodiments, the reservoir is an oil and gas reservoir, such as an oil and gas carbonate reservoir. In some embodiments, the reservoir may be an oil reservoir that has already been substantially depleted of oil. In some embodiments, the reservoir may be a fractured reservoir that contains trapped oil in matrices of the fractured reservoir. Thus, in some embodiments, the methods of the present disclosure may be used as part of a tertiary oil recovery process.

In some embodiments, carbon particles of the present disclosure penetrate into fractures or pores of reservoirs upon introduction. Thereafter, the at least one filler component may be released into the pores of the reservoir.

Release of at Least One Component of the Filler into the Reservoir

Introduction of carbon particles into a reservoir can be followed by the release of at least one component of a filler from the carbon particles into the reservoir. In some embodiments, the at least one component of a filler is an atom associated with the filler, a functional group associated with the filler, a moiety associated with the filler, and combinations thereof. For instance, in some embodiments, the at least one component of the filler that is released into the reservoir is a proton group associated with the filler (e.g., an H⁺ group from sulfuric acid). In some embodiments, the at least one component of the filler that is released into the reservoir is an entire filler molecule.

The release of the at least one component of a filler from the carbon particles into the reservoir can occur in various manners. For instance, in some embodiments, the release can occur in a prolonged, programmable, triggered, or self-controlled manner.

In some embodiments, the release of the at least one component of a filler from the carbon particles into the reservoir can occur in a gradual manner. For instance, in some embodiments, the release can occur in a gradual manner that lasts from about 1 hour to about 24 hours. In some embodiments, the release lasts from about 1 hour to about 12 hours. In some embodiments, the release lasts from about 1 hour to about 6 hours.

In some embodiments, the release of the at least one component of a filler from the carbon particles into the reservoir can occur in a delayed manner. For instance, in some embodiments, the release can have a delay of about 1 hour after the introduction of carbon particles into the reservoir. In some embodiments, the release can have a delay of more than about 1 hour after the introduction of carbon particles into a reservoir. In some embodiments, the delay may last from about 1 hour to about 6 hours after the introduction of carbon particles into a reservoir.

In some embodiments, the release of the at least one component of a filler from the carbon particles into the reservoir can occur as a function of a change in an environmental condition of the reservoir. In some embodiment, the environmental condition can include, without limitation, reservoir temperature, reservoir pressure, reservoir chemical composition, and combinations thereof. For instance, in some embodiments, the release can occur as a function of a change in the temperature of the reservoir. In some embodiments, an increase in reservoir temperature can result in an increase in the release of the at least one component of a filler.

In some embodiments, the release of the at least one component of a filler from the carbon particles into the reservoir can occur as a function of the hydrophilicity or hydrophobicity of the filler. For instance, in some embodiments, hydrophilic fillers may have a higher release rate than hydrophobic fillers. As such, in some embodiments, both the extent and rate of release can be optimized according to the hydrophobicity or hydrophilicity of the fillers in the carbon particles. For instance, in some embodiments, carbon particles with malonic acid as the filler may have a higher release rate of proton groups from the filler into the reservoir than carbon particles with the more hydrophobic adipic acid as the filler.

In some embodiments, the release of the at least one component of a filler from the carbon particles into the reservoir can occur as a function of a shift in a chemical equilibrium between the filler and at least one component of the filler. Without being bound by theory, a shift in a chemical equilibrium between the filler and at least one component of the filler can be dictated by Le Chatelier's principle in accordance with equation 1:

Filler⇄Filler*+Filler component (1)

For instance, in some embodiments, at least one component of a filler from a first filler molecule (e.g., H⁺ from a strong acid) may migrate into the reservoir from the carbon particles. As such, a subsequent decrease in the concentration of the at least one component of the filler (e.g., H⁺ from the strong acid) within the carbon particle (e.g., carbon shell) will force the ionization of additional filler components from fillers within the carbon particle (e.g., ionization of H⁺ from weak acids), and their subsequent migration into the reservoir.

In some embodiments, the release of the at least one component of a filler from the carbon particles into the reservoir can occur as a function of a multiphase and multiequilibria system in accordance with the scheme illustrated in equation 2:

Hydrophilic carbon particle phase⇄Reservoir⇄Hydrophobic carbon particle phase (2)

For instance, in some embodiments, carbon particles and fillers can form a hydrophobic phase and a hydrophilic phase with the reservoir components. In some embodiments, the fillers will be in the hydrophilic phase while the carbon particles will be in the hydrophobic phase. Thus, when the concentration of scales (e.g., carbonates) in the reservoir increases, the amount of at least one filler component (e.g., hydronium ions) inside the hydrophobic phase (e.g., hydrophobic enclosure within carbon particles) may decrease, thereby forcing more of the fillers (e.g., weak acids) to ionize in order to restore hydrophilicity inside the shell.

Chemical Treatment of Reservoirs

The at least one component of a filler may be utilized to chemically treat a reservoir in various manners. For instance, in some embodiments, the chemical treatment can include, without limitation, scale inhibition, corrosion inhibition, shale inhibition, and combinations thereof.

In some embodiments, the chemical treatment of a reservoir can include scale inhibition by the at least one component of a filler (e.g., embodiments where the filler includes a scale inhibitor, as previously described). In some embodiments, scale inhibition occurs by prevention of or interference with scale formation. In some embodiments, scale inhibition occurs by prevention of or interference with scale precipitation, scale reprecipitation, scale crystallization, scale adherence to reservoir surfaces, and combinations thereof. For instance, without being bound by theory, the at least one filler component in some embodiments may serve as a complexing or chelating agent that suppresses scale crystal growth. In some embodiments, scale inhibition can also be facilitated by absorption of scales by carbon particles.

The methods of the present disclosure can be used to inhibit the formation of various types of scales. For instance, in some embodiments, the scales include, without limitation, calcium carbonate, calcium sulfate, barium sulfate, strontium sulfate, iron sulfide, iron oxides, iron carbonate, sodium chloride, silicate oxides, phosphate oxides, and combinations thereof. In some embodiments, the inhibited scale is calcium carbonate.

In some embodiments, the chemical treatment of a reservoir can include shale inhibition by the at least one component of a filler (e.g., embodiments where the filler includes a shale inhibitor). In some embodiments, shale inhibition occurs by prevention of or interference with shale formation. In some embodiments, shale inhibition occurs by prevention of or interference with the swelling of clay minerals in shale formations. In some embodiments, shale inhibition occurs by prevention of or interference with the mixing of classic sedimentary rocks with mud and minerals (e.g., clay minerals and/or tiny fragments of minerals, such as quartz and calcite).

In some embodiments, the chemical treatment of a reservoir can include corrosion inhibition by the at least one component of a filler (e.g., embodiments where the filler includes a corrosion inhibitor). In some embodiments, corrosion inhibition occurs by prevention of or interference with corrosion.

The chemical treatment of reservoirs in accordance with the methods of the present disclosure can have various effects on a reservoir. For instance, in some embodiments, the chemical treatment can result in enhancement of oil and gas recovery from the reservoir. In some embodiments, the chemical treatment results in an increase in the oil recovery factor (i.e., ratio of recoverable oil to the volume of oil originally in place) of the reservoir. In some embodiments, the chemical treatment results in an increase in the oil recovery factor by at least 10%. In some embodiments, the chemical treatment results in an increase in the oil recovery factor by at least 50%. In some embodiments, the chemical treatment results in an increase in the oil recovery factor by between about 10% and about 50%.

Recovery of Carbon Particles from Reservoirs

In some embodiments, the methods of the present disclosure also include a step of recovering carbon particles from a reservoir. In some embodiments, the recovering occurs after the release of at least one component of a filler from the carbon particles into the reservoir.

In some embodiments, the carbon particles are recovered by drawing out the carbon particles from the reservoir. In some embodiments, the drawing out occurs by the use of a pump. In some embodiments, the carbon particles are recovered manually by recovering the carbon particles as they flow out of the reservoir.

In some embodiments, the carbon particles of the present disclosure are injected into a first location of a reservoir and collected from a second location of the reservoir. For instance, in some embodiments, the first location is an injection well, and the second location is a production well. In some embodiments, the injecting and the collecting occur from a single location (e.g., a wellbore) in a reservoir.

Association of Recovered Carbon Particles with Fillers

In some embodiments, the methods of the present disclosure can also include a step of associating the recovered carbon particles with additional fillers. For instance, in some embodiments, the association occurs by mixing the recovered carbon particles with a filler. Additional methods of associating recovered carbon particles with a filler can also be envisioned.

Reuse of Carbon Particles

In some embodiments, the methods of the present disclosure can also include a step of reusing the recovered carbon particles to chemically treat a reservoir. In some embodiments, the reusing of the carbon particles occurs after a step of associating the recovered carbon particles with additional fillers. In some embodiments, the reusing of the carbon particles occurs immediately after recovering the carbon particles from a reservoir.

Applications and Advantages

The carbon particles of the present disclosure can have various advantages. For instance, in some embodiments, the carbon particles of the present disclosure can be prepared in a facile manner without requiring multiple steps. In addition, the carbon particles of the present disclosure can be prepared in a cost effective manner due to the low cost of the starting materials and ease of production. Moreover, the carbon particles of the present disclosure can be environmentally friendly, nontoxic, and biodegradable

In addition, the carbon particles of the present disclosure can have optimal filler loading capacities. Moreover, the carbon particles of the present disclosure can accommodate various types and combinations of fillers. Likewise, the carbon particles of the present disclosure can be emptied easily and filled with different fillers (e.g., inhibitors) that can be used effectively over longer periods. Furthermore, the carbon particles of the present disclosure can provide self-controlled delivery of various fillers into a reservoir by various mechanisms that provide a prolonged and self-controlled mode of action. In fact, in some embodiments, the carbon particles of the present disclosure can be effective anywhere from several months up to several years.

As such, the carbon particles of the present disclosure can find numerous applications. For instance, in some embodiments, the carbon particles of the present disclosure can be utilized as tunable, affordable, environmentally-friendly, and long half-life encapsulated scale/corrosion inhibitors in the oil industry. In some embodiments, the carbon particles of the present disclosure can be especially effective in calcium carbonate reservoirs, which are known for their tight vugular porosity inhibition. In some embodiments, the carbon particles of the present disclosure can find applications as anti-scale and/or anti-corrosion inhibitors in various reservoirs, such as carbonate petroleum reservoirs. Moreover, the fillers in the carbon particles of the present disclosure can be tuned according to the need or stage of a process (e.g., an oilfield recovery process or stage).

In some embodiments, the carbon particles of the present disclosure can be optimal replacements for water-based delivery materials, which are known for their high cost, short half-life, shale formation (e.g., by swelling of the clay minerals in the formation), and consequent interruption of the oil production process. The large surface area and tunable surface chemistry of the particles are expected to ensure well-protected encapsulated materials that can be delivered effectively over prolonged periods of time, thereby ensuring greater oil production enhancement as well as minimal interruption of production.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Encapsulated Carbon Shells: Materials for Prolonged and Self-Controlled Calcium Carbonate Scale Inhibition

In this Example, Applicants outline the synthesis and characterization of carbon shells by the dehydration of inexpensive carbohydrate precursors. Applicants also outline a method of testing the carbon shells in carbonate reservoirs as antiscale agents.

Carbon shells in this Example were prepared from the dehydration of carbohydrates and their biopolymers. The carbon shells have shell structures that can be easily and efficiently loaded with a filler (e.g., a scale inhibitor and/or a corrosion inhibitor). Furthermore, the carbon shells can be coated by a solid inhibitor, friction reducing materials, and combinations thereof.

In this Example, the carbon shell itself may not be soluble in water. However, the carbon shell can be permeable to different types of fillers. The prolonged effect of the carbon shells is self-controlled and is based on a dynamic chemical equilibrium in the multiphase system rather than on a single spontaneous process that limits its use over a short period of time.

Carbon shells can be filled with a combination of strong acids and weak acids. The latter ones can act as chelating agents to prevent scale reprecipitation (e.g., phosphonate precipitation).

### EXAMPLE 1.1

### Synthesis of Carbon Shells

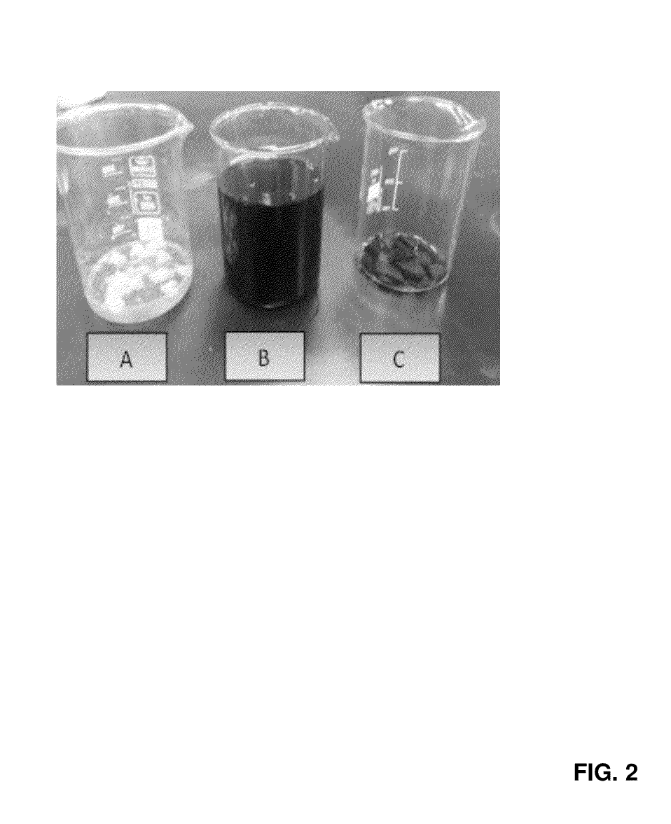

An example of a protocol for the synthesis of carbon shells is outlined in FIG. 2. In this example, the carbon shell was prepared by the following protocol: (A) addition of 75 mL of concentrated sulfuric acid to 10 grams of glucose followed by mixing until the solution's color becomes completely black; (B) addition of 225 mL of deionized water and equilibration of the reaction mixture while stirring; and (C) filtering and drying of reaction mixture using organic solvents.

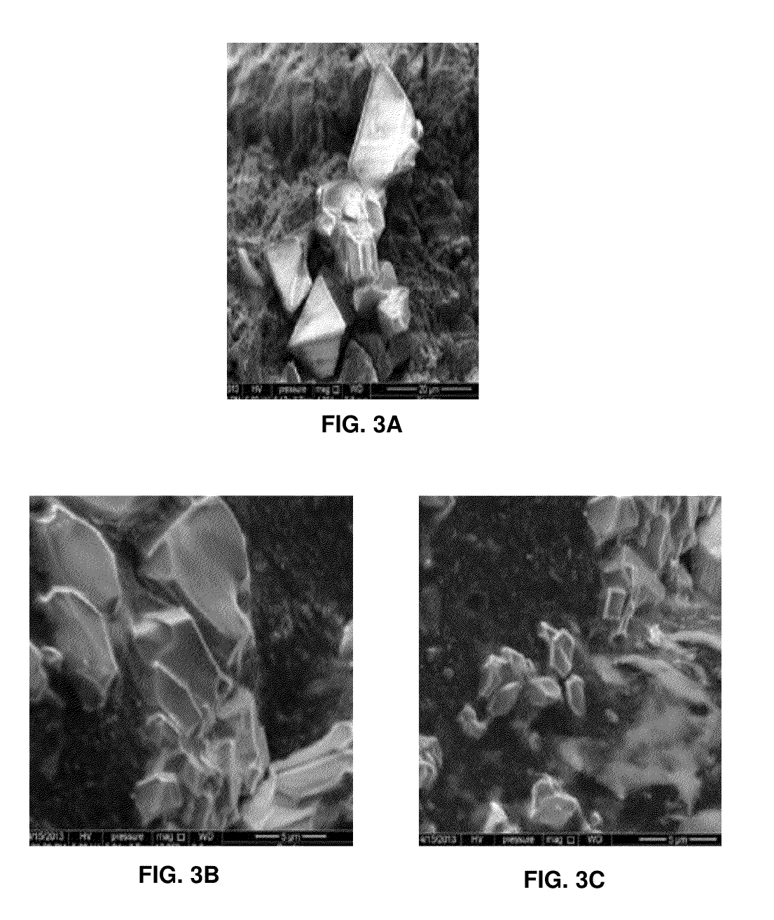

Low magnification scanning electron microscopy (SEM) images of the produced carbon shells are shown in FIG. 3. The low magnification SEM images (FIG. 3A) shows particles of different sizes and different morphologies. The higher magnification images (FIGS. 3B-C) show that these particles are highly faceted. The edges of the particles are sharp. Moreover, the morphology is unique and observed in highly stressed particles. For instance, the glucose-based carbon shell has a similar structure and morphology to graphitic carbon but could contain substantial fraction of sp³ bonding.

### EXAMPLE 1.2

### Characterization of Carbon Shells

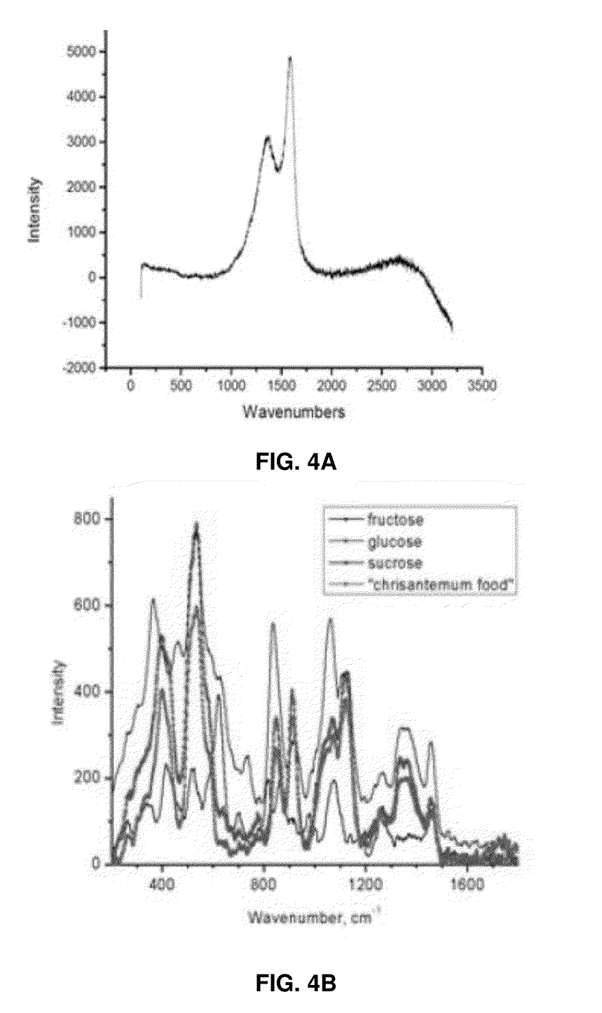

Raman spectroscopy was used to identify the carbon shells' structures. For instance, FIG. 4A is a Raman spectrum of a carbon shell from Example 1.1. FIG. 4B is a Raman spectrum of various carbon shell precursors.

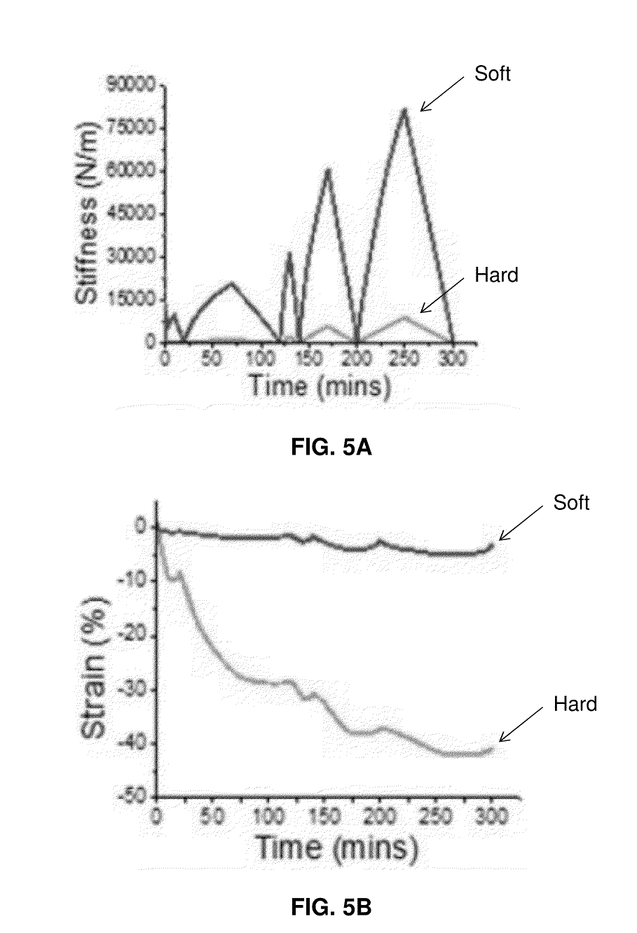

In preliminary experiments, in order to confirm the wide spectrum of mechanical strength of carbon acid shells, applicants measured the mechanical stiffness of two carbon acid shell products by dynamic mechanical analysis (DMA) using TA Q800 equipment. Stiffness, load, unload, and strain load/unload measurements were carried out. As shown in FIG. 5, both the stiffness (FIG. 5A) and strain (FIG. 5B) experiments show a strong dependence of the mechanical properties of the carbon shells on the synthesis parameters. For instance, carbon shell sample stiffness testing shows ten times higher values for one of the samples than the other (FIG. 5A).

### EXAMPLE 1.3

### Mode of Action of Carbon Shells

Without being bound by theory, the mode of action of carbon shells in carbon reservoirs can be envisioned by considering the example of a carbon shell loaded with a first acid (e.g., sulfuric acid) and a second acid (e.g., malonic acid or COOH—CH₂—COOH). In the presence of calcium carbonate (CaCO₃), the first acid (or a component thereof, such as H⁺) will migrate to the outside of the shell to react with the calcium carbonate. According to Le Chatelier's principle, the subsequent decrease in H⁺ concentration will then lead to a stress in the equilibrium system for malonic acid, which is illustrated herein:

COOH—CH₂—COOH⇄(COOH—CH₂—COO)⁻+H⁺

To respond to the imbalance in the equilibrium, the weak malonic acid will ionize to give more H⁺, which will lead to the prolonged mode of action. As such, both the extent and rate of the reaction can be optimized according to the hydrophobicity/hydrophilicity proportion of the loaded material.

Accordingly, both the rate and extent of the reaction will decrease when the more hydrophobic 6-carbon adipic acid (COOH—(CH₂)₄—COOH) replaces the 3-carbon malonic acid in the above mixture.

As such, the mode of action of the carbon shells can be explained in terms of the multiphase and multiequilibria system under the following scheme:

Hydrophilic carbon shell phase⇄Oil reservoir⇄Hydrophobic carbon shell phase

Other alternative equilibria of fillers, such as making use of buffer systems, can also be envisioned.

### EXAMPLE 1.4

### Effect of Variation of Hydrophobicity/Hydrophilicity Ratio on the Performance of Carbon Shells

Applicants envision that carbon shell modification can be studied from three perspectives: (1) variation of carbon atoms of the fillers (i.e., loaded materials); (2) variation of carbon atoms in the carbohydrate precursor; and (3) combinations thereof. Moreover, as illustrated in Table 1, various possibilities may be obtained by using different combinations of the precursor and fillers (i.e., loaded materials).

TABLE 1
Variations in carbohydrate precursors and fillers (loaded materials).

| Precursor | Loaded materials |
|---|---|
| Glucose | Sulfuric acid |
| Fructose | Oxalic acid (2 carbons) |
| Maltose | Malonic acid (3 carbons) |
| Sucrose | Adipic acid (6 carbons) |
| Polysaccharide (e.g., starch or cellulose) | Polyaspartic acid |

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of chemically treating a reservoir, said method comprising:
introducing carbon particles into the reservoir,
wherein the carbon particles are associated with a filler,
wherein at least one component of the filler is released into the reservoir from the carbon particles, and
wherein the at least one component of the filler chemically treats the reservoir.

2. The method of claim 1, wherein the introducing comprises injection of the carbon particles into the reservoir.

3. The method of claim 1, wherein the carbon particles comprise a carbon source, wherein the carbon source is selected from the group consisting of carbohydrates, polymers, biopolymers, carbon nanotubes, graphenes, graphene oxides, graphites, precursors thereof, derivatives thereof, and combinations thereof.

4. The method of claim 1, wherein the filler is associated with the carbon particles through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

5. The method of claim 1, wherein the filler is encapsulated within the carbon particles.

6. The method of claim 1, wherein the filler is selected from the group consisting of acids, scale inhibitors, corrosion inhibitors, shale inhibitors, and combinations thereof.

7. The method of claim 1, wherein the filler is an acid selected from the group consisting of sulfuric acid, polycarboxylic acids, dicarboxylic acids, oxalic acid, malonic acid, succinic acid, adipic acid, polyaspartic acid, polyprotic organic acids, polymaleic acid, composite acids, and combinations thereof.

8. The method of claim 1, wherein the filler is a scale inhibitor.

9. The method of claim 8, wherein the scale inhibitor is selected from the group consisting of nitrilotriacetates, phosphonates, polyphosphonates, acrylic acids, polyacrylic acids, phosphinopolyacrylates, maleic acids, polymaleic acid, phosphonic acids, sulfonic acids, polyaspartate, carboxy methyl inulin, polycarboxylic acid, and combinations thereof.

10. The method of claim 1, wherein the at least one component of the filler is an atom associated with the filler, a functional group associated with the filler, a moiety associated with the filler, and combinations thereof.

11. The method of claim 1, wherein the at least one component of the filler comprises an entire filler molecule.

12. The method of claim 1, wherein the chemical treatment is selected from the group consisting of scale inhibition, corrosion inhibition, shale inhibition, and combinations thereof.

13. The method of claim 1, wherein the chemical treatment comprises scale inhibition.

14. The method of claim 1, wherein the chemical treatment results in enhancement of oil and gas recovery from the reservoir.

15. The method of claim 1, wherein the reservoir is selected from the group consisting of carbonate reservoirs, limestone reservoirs, carbonate petroleum reservoirs, sandstone reservoirs, oil and gas reservoirs, and combinations thereof.

16. The method of claim 1, wherein the reservoir is an oil and gas carbonate reservoir.

17. The method of claim 1, further comprising a step of recovering the carbon particles from the reservoir.

18. The method of claim 17, further comprising a step of associating the recovered carbon particles with a filler.

19. The method of claim 17, further comprising a step of reusing the recovered carbon particles.

20. A method of making carbon particles, said method comprising:
mixing a carbon source with a dehydrating agent to form a reaction mixture,
wherein the mixing results in assembly of the carbon particles from the carbon source.

21. The method of claim 20, wherein the carbon source is selected from the group consisting of carbohydrates, polymers, biopolymers, carbon nanotubes, graphenes, graphene oxides, graphites, precursors thereof, derivatives thereof, and combinations thereof.

22. The method of claim 20, wherein the carbon source comprises carbohydrates.

23. The method of claim 22, wherein the carbohydrates are selected from the group consisting of sugars, monosaccharides, disaccharides, polysaccharides, glucose, sucrose, fructose, maltose, galactose, ribose, starch, cellulose, amylose, pyranose, and combinations thereof.

24. The method of claim 20, wherein the dehydrating agent is selected from the group consisting of sulfuric acid, sodium hydroxide, potassium hydroxide, phosphorus pentoxide, copper sulfate, calcium chloride, zinc chloride, barium perchlorate, calcium perchlorate, magnesium perchlorate, calcium sulfate, calcium oxide, and combinations thereof.

25. The method of claim 20, wherein the mixing occurs by stirring the reaction mixture.

26. The method of claim 20, further comprising a step of associating the carbon particles with a filler.

27. The method of claim 26, wherein the associating occurs in situ during the mixing step.

28. The method of claim 26, wherein the associating occurs after the formation of the carbon particles.

29. The method of claim 28, wherein the associating occurs by mixing the formed carbon particles with the filler.

30. The method of claim 26, wherein the filler becomes associated with the carbon particles through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

31. The method of claim 26, wherein the filler becomes encapsulated within the carbon particles.

32. The method of claim 26, wherein the filler is derived from the dehydrating agent.

33. The method of claim 26, wherein the filler is a component of the dehydrating agent.

33. The method of claim 26, wherein the filler is selected from the group consisting of acids, scale inhibitors, corrosion inhibitors, shale inhibitors, and combinations thereof.

34. The method of claim 26, wherein the filler is an acid selected from the group consisting of sulfuric acid, polycarboxylic acids, dicarboxylic acids, oxalic acid, malonic acid, succinic acid, adipic acid, polyaspartic acid, polyprotic organic acids, polymaleic acid, composite acids, and combinations thereof.

35. The method of claim 26, wherein the filler is a scale inhibitor.

36. The method of claim 35, wherein the scale inhibitor is selected from the group consisting of nitrilotriacetates, phosphonates, polyphosphonates, acrylic acids, polyacrylic acids, phosphinopolyacrylates, maleic acids, polymaleic acid, phosphonic acids, sulfonic acids, polyaspartate, carboxy methyl inulin, polycarboxylic acid, and combinations thereof.

37. The method of claim 20, wherein the assembly comprises dehydration of the carbon source by the dehydrating agent.

38. The method of claim 20, wherein the assembly comprises polymerization of the carbon source.

39. A carbon particle for chemically treating a reservoir, wherein the carbon particle comprises:
a carbon source; and
a filler associated with the carbon particle.

40. The carbon particle of claim 39, wherein the carbon source is selected from the group consisting of carbohydrates, polymers, biopolymers, carbon nanotubes, graphenes, graphene oxides, graphites, precursors thereof, derivatives thereof, and combinations thereof.

41. The carbon particle of claim 39, wherein the carbon source comprises carbohydrates.

42. The carbon particle of claim 41, wherein the carbohydrates are selected from the group consisting of sugars, monosaccharides, disaccharides, polysaccharides, glucose, sucrose, fructose, maltose, galactose, ribose, starch, cellulose, amylose, pyranose, and combinations thereof.

43. The carbon particle of claim 39, wherein the filler is associated with the carbon particles through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

44. The carbon particle of claim 39, wherein the filler is encapsulated within the carbon particles.

45. The carbon particle of claim 39, wherein the filler is selected from the group consisting of acids, scale inhibitors, corrosion inhibitors, shale inhibitors, and combinations thereof.

46. The carbon particle of claim 39, wherein the filler is an acid selected from the group consisting of sulfuric acid, polycarboxylic acids, dicarboxylic acids, oxalic acid, malonic acid, succinic acid, adipic acid, polyaspartic acid, polyprotic organic acids, polymaleic acid, composite acids, and combinations thereof.

47. The carbon particle of claim 39, wherein the filler is a scale inhibitor.

48. The carbon particle of claim 47, wherein the scale inhibitor is selected from the group consisting of nitrilotriacetates, phosphonates, polyphosphonates, acrylic acids, polyacrylic acids, phosphinopolyacrylates, maleic acids, polymaleic acid, phosphonic acids, sulfonic acids, polyaspartate, carboxy methyl inulin, polycarboxylic acid, and combinations thereof

49. The carbon particle of claim 39, wherein the carbon particle is in the shape of at least one of shells, discs, spheres, tubes, encapsulated structures, and combinations thereof.

50. The carbon particle of claim 39, wherein the carbon particle is in the shape of shells.

51. The carbon particle of claim 39, wherein the carbon particle comprises a hydrophobic surface and a hydrophilic core.

52. The carbon particle of claim 39, wherein the carbon particle comprises surface areas ranging from about 500 m²/g to about 2,500 m²/g.

53. The carbon particle of claim 39, wherein the carbon particle comprises diameters ranging from about 5 μm to about 500 μm.

54. The carbon particle of claim 39, wherein the carbon particle comprises densities ranging from about 250 mg/cm³ to about 1,000 mg/cm³.

55. The carbon particle of claim 39, wherein the carbon particle has an acid capacity ranging from about 0.5 moles of H⁺/mg to about 10 moles of H⁺/mg.
